(19) United States
(12) Patent Application Publication
(10) Pub. No.: US 2012/0303295 A1
(43) Pub. Date: Nov. 29, 2012

(54) DIRECTION SENSING APPARATUS

(75) Inventors: CHI-TIEN YEH, HSINCHU COUNTY (TW); WEI-YANG OU, HSINCHU COUNTY (TW); JUI-YUAN TSAI, HSINCHU COUNTY (TW)

(73) Assignee: SITRONIX TECHNOLOGY CORP., HSINCHU COUNTY (TW)

(21) Appl. No.: 13/423,489

(22) Filed: Mar. 19, 2012

(30) Foreign Application Priority Data
May 27, 2011 (TW) 100118552

(51) Int. Cl. G06F 19/00

(52) U.S. Cl. 702/41

(57) ABSTRACT

The direction sensing apparatus according to the present invention comprises a sensing circuit, a computing module, and a judging unit. The sensing circuit detects the gravity direction of an object and produces at least a detecting signal. The computing module receives the detecting signal, and produces at least a computing value according to at least a threshold value and the detecting signal. The judging unit receives the computing value, and gives a state of gravity direction of the object according to the computing value. Thereby, the present invention shrinks the area of circuits and hence saving cost by means of the simple circuit structure of the computing module.

### FIELD OF THE INVENTION

The present invention relates generally to a sensing apparatus, and particularly to a direction sensing apparatus capable of detecting rotation of a display.

### BACKGROUND OF THE INVENTION

With the progress and development of technologies, various handheld electronic devices, such as mobile phones and personal digital assistants (PDAs), are provided. Owing to their convenience in carrying and multiple functions, handheld electronic devices are popular increasingly. Thanks to technological development, handheld devices can execute different corresponding functions according to their orientations. Taking the most popular daily-used devices, mobile phones, for example, when a user searches data or views pictures on a mobile phone, the screen may need to be rotated for convenient viewing or operations. For a general bar-type mobile phone, there are two methods for controlling screen rotation: one is automatic control according to the detection of gravity (G) sensors; the other is manual selection of the options regarding screen rotation by the user via buttons.

Nonetheless, while detecting rotations of a mobile phone using G sensors, it is required to use a sensing apparatus for judging if the mobile phone has rotated to a certain angle for controlling the mobile phone to rotate the screen correspondingly. The circuit of the judging unit according to prior art is complicated, which increases the cost. In addition, when the mobile phone rotates the screen automatically, it usually happens that the mobile phone rotates its screen repeatedly because the rotation angle of the screen lies around the switching angle and hence the judging unit is unable to judge correctly if screen rotation is required. This brings inconvenience for users.

According to the other method, a user needs to push buttons manually then screen rotation of his/her mobile phone is executed. It is common that the user has to switch to multiple frames before he/she can choose the options in the menu. Thereby, the operating interface is quite complex and inconvenient. Consequently, the methods for controlling screen rotation described above cannot fit a user's usual practices and convenience; a user cannot rotate his/her screen conveniently and rapidly according to his/her intentions.

### SUMMARY

An objective of the present invention is to provide a direction sensing apparatus, which shrinks the area of circuits and hence saving cost by means of the simple circuit structure of a computing module.

Another objective of the present invention is to provide a direction sensing apparatus, which receives a hysteresis control signal using a computing module for achieving stability of screen rotation.

The direction sensing apparatus according to the present invention comprises a sensing circuit, a computing module, and a judging unit. The sensing circuit detects the gravity direction of an object and produces at least a detecting signal. The computing module receives the detecting signal, and produces at least a computing value according to at least a threshold value and the detecting signal. The judging unit receives the computing value, and gives a direction state of the object according to the computing value. Thereby, the present invention shrinks the area of circuits and hence saving cost by means of the simple circuit structure of the computing module.

Moreover, the computing module of the direction sensing apparatus according to the present invention can further receive a hysteresis control signal and compare the detecting signal according to the hysteresis signal and the threshold value for producing the computing value, which is provided for the judging unit for determining the direction state of the object. Accordingly, stability of screen rotation is achieved by means of the hysteresis control signal.

### BRIEF DESCRIPTION OF THE DRAWINGS

FIG. 1 shows a block diagram according to a preferred embodiment of the present invention;

FIG. 2 shows a circuit diagram of the computing module according to a preferred embodiment of the present invention;

FIG. 3 shows a coordinate graph of the rotation angle on the sensing plane in FIG. 2 according to a preferred embodiment of the present invention;

FIG. 4 shows a coordinate graph of the rotation angle on the sensing plane in FIG. 2 according to another preferred embodiment of the present invention;

FIG. 5 shows a circuit diagram of the computing module according to another preferred embodiment of the present invention;

FIG. 6 shows a coordinate graph of the rotation angle on the sensing plane in FIG. 5 according to a preferred embodiment of the present invention;

FIG. 7 shows a coordinate graph of the rotation angle on the sensing plane in FIG. 5 according to another preferred embodiment of the present invention;

FIG. 8 shows a block diagram according to another preferred embodiment of the present invention;

FIG. 9A shows a circuit diagram of the hysteresis circuit according to a preferred embodiment of the present invention;

FIG. 9B shows a circuit diagram of the hysteresis circuit according to another preferred embodiment of the present invention;

FIG. 10 shows a circuit diagram of the computing module according to another preferred embodiment of the present invention;

FIG. 11 shows an output truth table of the first computing unit in FIG. 10 according to a preferred embodiment of the present invention;

FIG. 12 shows a coordinate graph of the rotation angle on the sensing plane in FIG. 10 according to a preferred embodiment of the present invention;

FIG. 13 shows an output truth table of the first computing unit in FIG. 10 according to another preferred embodiment of the present invention;

FIG. 14 shows a coordinate graph of the rotation angle on the sensing plane in FIG. 10 according to another preferred embodiment of the present invention;

FIG. 15 shows a circuit diagram of the computing module according to another preferred embodiment of the present invention; and

FIG. 16 shows a coordinate graph of the rotation angle on the sensing plane in FIG. 15 according to a preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

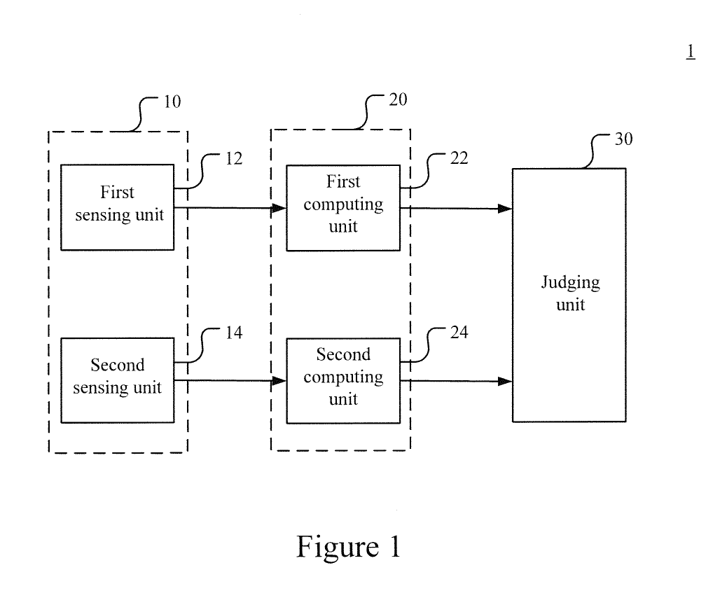

FIG. 1 shows a block diagram according to a preferred embodiment of the present invention. As shown in the figure, the direction sensing apparatus 1 according to the present invention comprises a sensing circuit 10, a computing module 20, and a judging unit 30. The sensing circuit 10 is used for detecting the gravity direction of an object and producing at least a detecting signal. The sensing circuit 10 can convert the physical quantity (such as the variation in capacitance or resistance) coming from external gravity-sensitive devices to voltage for the computing module 20. According to the present embodiment, the external gravity-sensitive device responds to the rotation of the object on a plane (two-dimensional), for example, the rotation of the object on the XY plane, the XZ plane, or the YZ plane.

The computing module 20 is coupled to the sensing circuit 10 for receiving at least a detecting signal produced by the sensing circuit 10, and producing at least a computing value according to at least a threshold value and the detecting signal. According to the present embodiment, the computing module 20 can compare the detecting signal according to the threshold value and produce the computing value by merely using a comparator. The detailed circuit of the computing module 20 will be described later. Thereby, the area of circuit is shrunk and the cost is saved by means of the simple circuit structure of the computing module 20.

The judging unit 30 is coupled to the computing module 20 for receiving the computing value output by the computing module 20, and giving a state of gravity direction of the object according to the computing value. Thereby, the judging unit 30 can know that the object rotates on a plane (the XY plane, the XZ plane, and the YZ plane). In other words, the judging unit 30 can know if the rotation angle of the object on the plane exceeds a predetermined angle (the threshold value) currently. If so, the judging unit 30 will produce a control signal and transmit the control signal to subsequent circuits. Thereby, the subsequent circuits can execute the corresponding actions. For example, when the present embodiment is applied to a handheld device such as a mobile phone or an electronic book, according to the computing value, the judging unit 30 knows that the handheld device rotates exceeding the predetermined angle on the plane. Hence, the judging unit 30 produces the control signal and transmits it to the subsequent circuits, which controls the screen of the handheld device according to the control signal, and switches the angle of the screen correspondingly.

Refer again to FIG. 1. The sensing circuit 10 of the direction sensing apparatus according to the present invention comprises a first sensing unit 12 and a second sensing unit 14. The first sensing unit 12 detects the variation of the physical quantity (such as the variation in capacitance or resistance) of the external gravity-sensitive device along a first axis and converts it to voltage and thus producing a first detecting signal. The second sensing unit 14 detects the variation of the physical quantity (such as the variation in capacitance or resistance) of the external gravity-sensitive device along a second axis and converts it to voltage and thus producing a second detecting signal. According to the preset embodiment, when the direction sensing apparatus 1 is used for sensing rotation on the XY plane, the first sensing unit 12 is used for sensing motions along the X-axis direction, while the second sensing unit 14 is used for sensing motions along the Y-axis direction. Thereby, by means of the first and the second sensing units 12, 14, motions along the X-axis and the Y-axis directions are sensed, respectively. The subsequent circuits can hence know rotation on the XY plane.

In addition, the computing module 20 of the direction sensing apparatus 1 according to the present invention comprises a first computing unit 22 and a second computing unit 24. The first computing unit 22 is coupled to the first sensing unit 12 for receiving the first detecting signal output by the first sensing unit 12 and producing a first computing value according to a first threshold value and the first detecting signal. The second computing unit 24 is coupled to the second sensing unit 14 for receiving the second detecting signal output by the second sensing unit 14 and producing a second computing value according to a second threshold value and the second detecting signal. Thereby, the judging unit 30 according to the present invention can judge the state of gravity direction of the object according to the first and the second computing values.

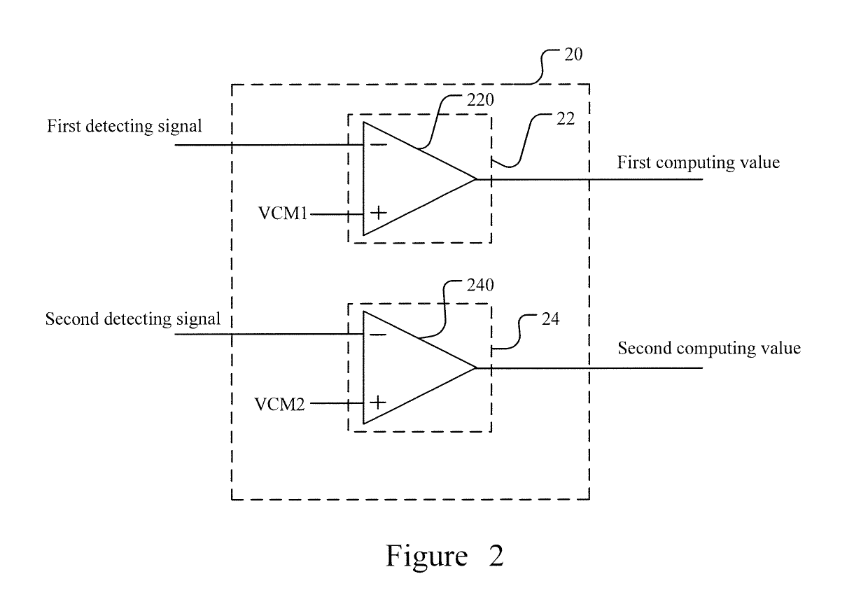

FIG. 2 shows a circuit diagram of the computing module according to a preferred embodiment of the present invention. As shown in the figure, the first and the second computing units 22, 24 comprise a first comparing unit 220 and a second comparing unit 240, respectively. The first comparing unit 220 has a first input and a second input. The first input of the first comparing unit 220 receives the first detecting signal; the second input of the first comparing unit 220 receives the first threshold value VCM1. The first comparing unit 220 compares the first detecting signal with the first threshold value VCM1 and produces the first computing value. Likewise, the second comparing unit 240 has a first input and a second input. The first input of the second comparing unit 240 receives the second detecting signal; the second input of the second comparing unit 240 receives the second threshold value VCM2. The second comparing unit 240 compares the second detecting signal with the second threshold value VCM2 and produces the second computing value. Thereby, the judging unit 30 can give the state of gravity direction of the object according to the first and the second computing values.

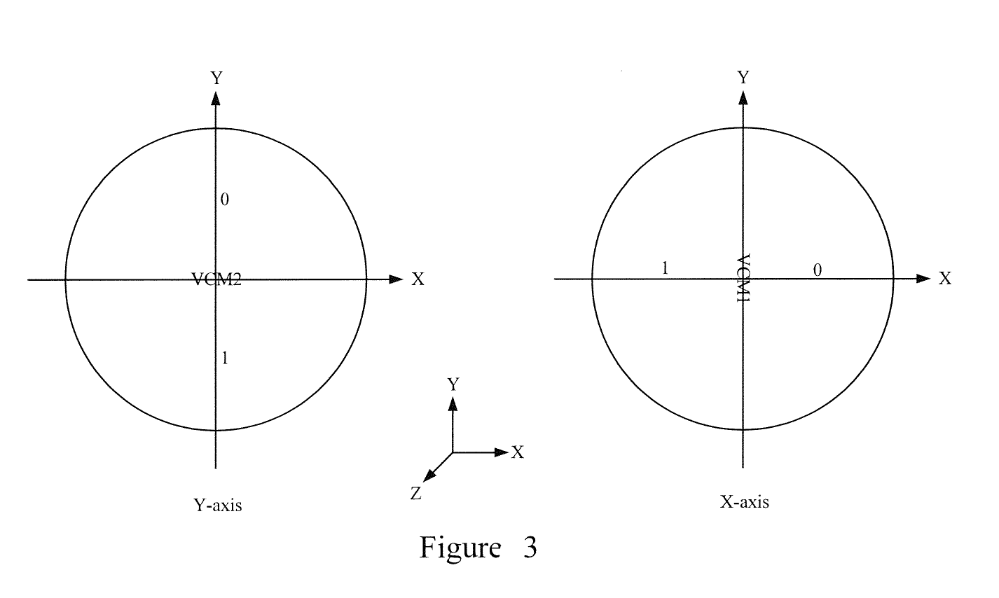

FIG. 3 shows a coordinate graph of the rotation angle on the sensing plane in FIG. 2 according to a preferred embodiment of the present invention. As shown in the figure, according to the present embodiment, sensing if rotation of the object (with the external gravity sensing device) exceeds 0-, 90-, 180-, and 270-degree boundaries is used as an example. The sensing of the rotation of the object (with the external gravity sensing device) on a plane by the direction sensing apparatus 1 according to the present embodiment can be divided into X-axis sensing and Y-axis sensing. The XY coordinates on the right of FIG. 3 represent X-axis sensing, while the XY coordinates on the left of FIG. 3 represent Y-axis sensing. Because according to the present embodiment 0, 90, 180, 270 degrees are used as boundaries sensing rotation of the object, the first threshold value VCM1 and the second threshold value VCM2 for the comparing unit can be set. In the present embodiment, the first threshold value VCM1 is the first detecting signal output by the first sensing unit 12 and received by the first computing unit 22 when the X-axis is in equilibrium (no gravity) (namely, the voltage level of the center point of the first detecting signal); the second threshold value VCM2 is the second detecting signal output by the second sensing unit 14 and received by the second computing unit 24 when the Y-axis is in equilibrium (no gravity) (namely, the voltage level of the center point of the second detecting signal). In FIG. 3, the X-axis sensing uses the Y-axis as the boundary. Define 0 to the right of the Y-axis and 1 to the left; define 0 to the top of the X-axis and 1 to the bottom. It is known from the above that while the object is rotating on the XY plane, there can be four states. When the object rotates to the first quadrant of the XY plane (namely, 0 to 90 degrees), [XY]=00; to the second quadrant (namely, 90 to 180 degrees), [XY]=10; to the third quadrant (namely, 180 to 270 degrees), [XY]=11; and to the fourth quadrant (namely, 270 to 360 degrees), [XY]=01. Thereby, according to the four states, the angle of the object on the XY plane can be deduced. Accordingly, signals can be output to the handheld electronic device for switching the angle of its screen (the direction sensing apparatus is placed in the handheld electronic device). The handheld electronic device is not limited to a mobile phone. Other devices such as a projector, a digital camera, and a digital photo frame are also applicable.

Besides, because the first and the second threshold values VCM1, VCM2 of the comparing unit correspond to the rotation angles, which are 0, 90, 180, 270 degrees according to the present embodiment, of the object (with an external gravity-sensitive device) on the XY plane, specific angles corresponding to the first and the second threshold values VCM1, VCM2 can be set. When the direct sensing apparatus according to the present invention detects that the object rotates to the specific angle on the XY plane, the screen of the handheld electronic device is switched correspondingly.

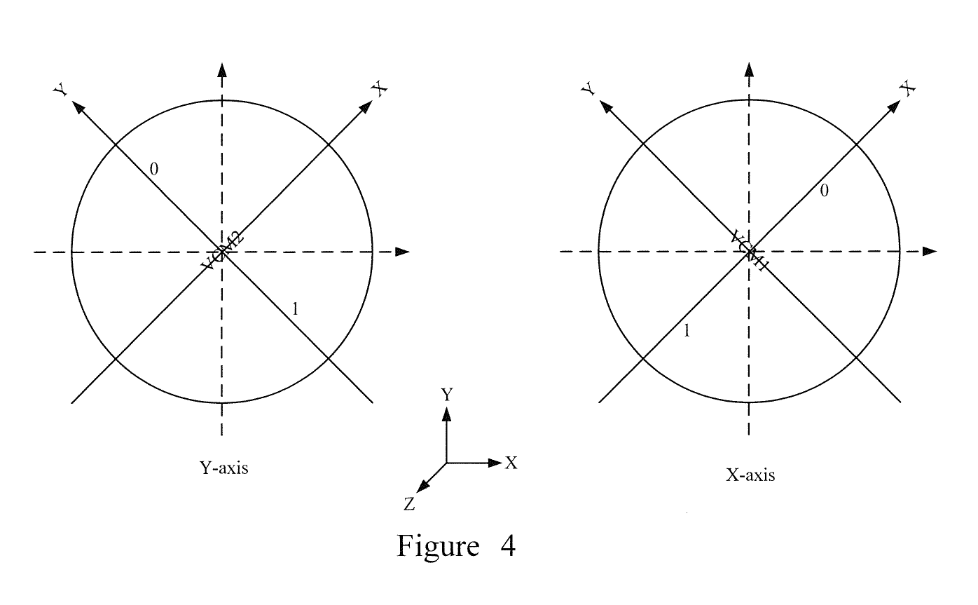

FIG. 4 shows a coordinate graph of the rotation angle on the sensing plane according to another preferred embodiment of the present invention. As shown in the figure, the difference between the present embodiment and the one in FIG. 3 is that the sensing circuit 10 according to the present embodiment is configured to sense 45-, 135-, 225-, and 315-degree rotations of the object. Thereby, the X-axis and the Y-axis on the XY plane is rotated counterclockwise to 45 degrees for sensing if the object exceeds 45, 135, 225, and 315 degrees for switching the screen angle on the handheld electronic device. Likewise, although the two embodiments described adopt 0 and 45 degrees as examples, the present invention is not limited to them. A person having ordinary skill in the art can easily deduce from the above description that any angle can also achieve the same objective. Hence, other angles will not be described in more details.

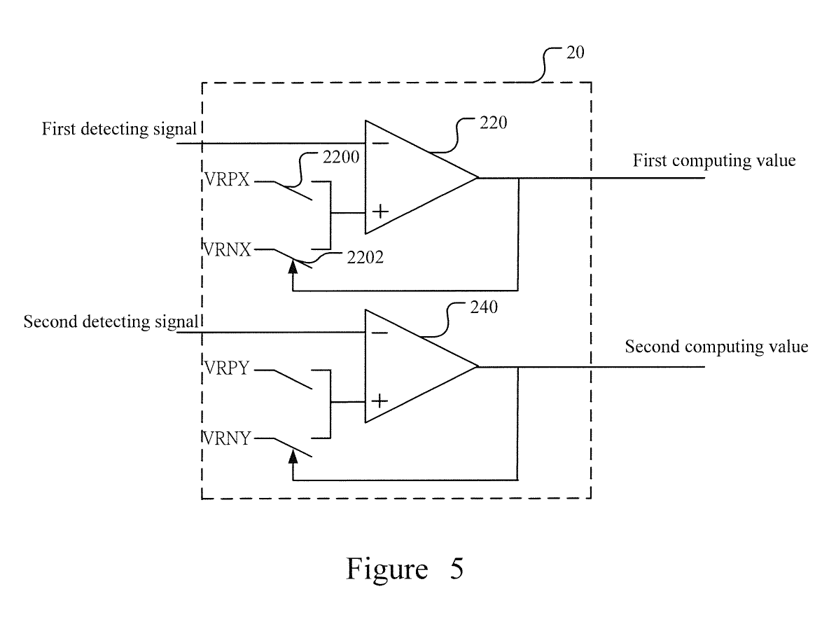

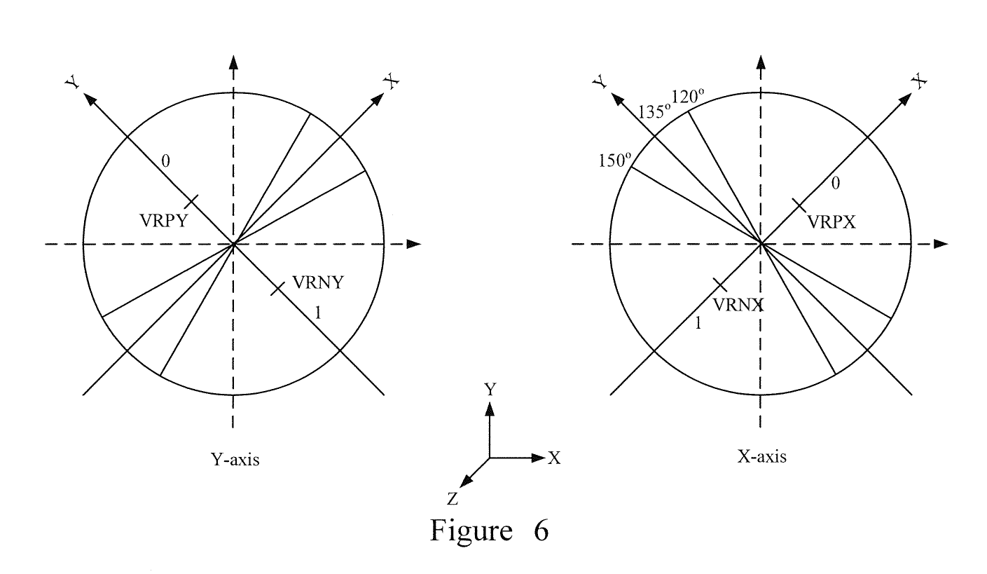

FIG. 5 and FIG. 6 show a circuit diagram of the computing module and a coordinate graph of the rotation angle on the sensing plane according to another preferred embodiment of the present invention. As shown in the figures, the difference between the present embodiment and the one in FIG. 2 is that the computing module 20 according to the present embodiment further receives at least a hysteresis control signal, which can come from the comparing unit or the judging unit 30, and determines the threshold value according to the hysteresis control signal. In other words, the first comparing unit 220 according to the present embodiment further comprises a first switch 2200 and a second switch 2202. The first switch 2200 is coupled to the second input of the first comparing unit 220 for receiving a first hysteresis threshold value VRPX; the second switch 2202 is coupled to the second input of the first comparing unit 220 for receiving a second hysteresis threshold value VRNX. The first and the second switches 2200, 2202 are controlled by the first computing value, which is used as the hysteresis control signal for the first and the second switches 2200, 2202, output by the first comparing unit 220. The first and the second switches 2200, 2202 transmit the first hysteresis threshold value VRPX or the second hysteresis threshold value VRNX to the second input of the first comparing unit 220 according to the first computing value, which is the hysteresis control signal, for producing the first computing value.

The first comparing unit 220 is used for sensing motions along the X-axis as shown in the XY coordinates on the right of FIG. 6. The present embodiment senses if the object exceeds 45, 135, 225, and 315 degrees for switching the screen angle on the handheld electronic device correspondingly. Taking 45 degrees for example, the First hysteresis threshold value VRPX and the second hysteresis threshold value VRNX according to the present embodiment are used for increasing the front and rear buffer angles at 135 degrees. According to the present embodiment, positive and negative 15 degrees are set as buffer angles. When the object on the XY plane rotates counterclockwise to exceeding 135 degrees, the judging unit 30 will not judge to switch the screen of the handheld electronic device. Instead, the object has to continue to rotate counterclockwise until exceeding 150 degrees, or to rotate clockwise to smaller than 120 degrees then the judging unit 30 will produce the control signal and transmit the control signal to the subsequent circuits for switching the screen of the handheld electronic device correspondingly. The first detecting signal received by the first input of the first comparing unit 220 can correspond to the rotation angle of the object. (In FIGS. 3 and 4, the first threshold value VCM1 is the first detecting signal, namely, the voltage level of the center point of the first detecting signal, output by the first sensing unit 12 and received by the first computing unit 22 when the X-axis is under equilibrium (no any gravity). In FIG. 6, the first hysteresis threshold value VRPX is the first detecting signal output by the first sensing unit 12 and received by the first computing unit 22 when the X-axis is at +120 degrees; the second hysteresis threshold value VRNX is the first detecting signal output by the first sensing unit 12 and received by the first computing unit 22 when the X-axis is at +150 degrees.) The first hysteresis threshold value VRPX can determine the corresponding rotation angle of the object for switching the handheld electronic device. Assuming the initial state is at 90 degrees and the output of the comparing unit is 0. The hysteresis control signal will turn on the second switch 2202. When the handheld electronic device rotates counterclockwise to exceed 150 degrees, the output of the comparing unit changes to 1 from 0 and hence turns on the first switch 2200. When the handheld electronic device rotates clockwise to be less than 120 degrees, the output of the comparing unit changes from 1 to 0. By means of the first and the second hysteresis threshold values VRPX, VRNX, a 30-degree hysteresis effect is generated, which avoids 0/1 beating of the output of the first comparing unit 220 in the zone between 120 and 150 degrees. Accordingly, the screen of the handheld electronic device will not rotate rashly and thus giving a more stable result. Similarly, the operating principle of the second comparing unit 240 is the same as that of the first comparing unit 220, and will not be described in details again.

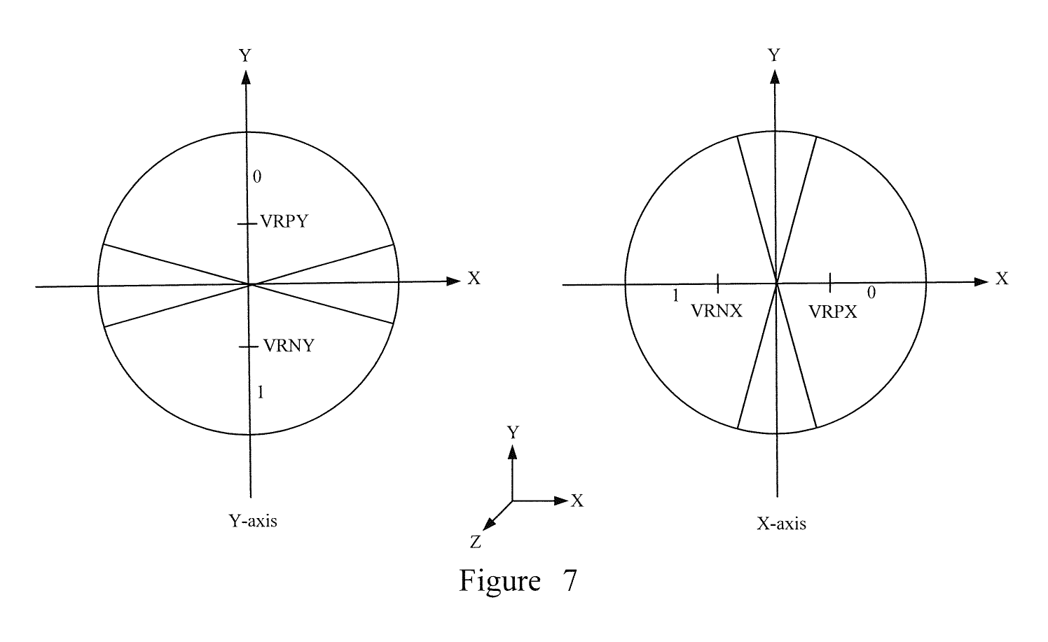

FIG. 7 shows a coordinate graph of the rotation angle on the sensing plane in FIG. 5 according to another preferred embodiment of the present invention. As shown in the figure, the difference between the present embodiment and the one in FIG. 5 is that the sensing circuit 10 according to the present embodiment is configured for sensing 0-, 90-, 180-, and 270-degree rotations of the object. Thereby, the X-axis and the Y-axis on the XY plane sense if the object exceeds 0 plus and minus 15 degrees for switching the screen angle. Although the present embodiment adopts 0 and 45 degrees as examples, the present invention is not limited to them. A person having ordinary skill in the art can easily deduce from the above description that any angle can also achieve the same objective. Hence, other angles will not be described in more details.

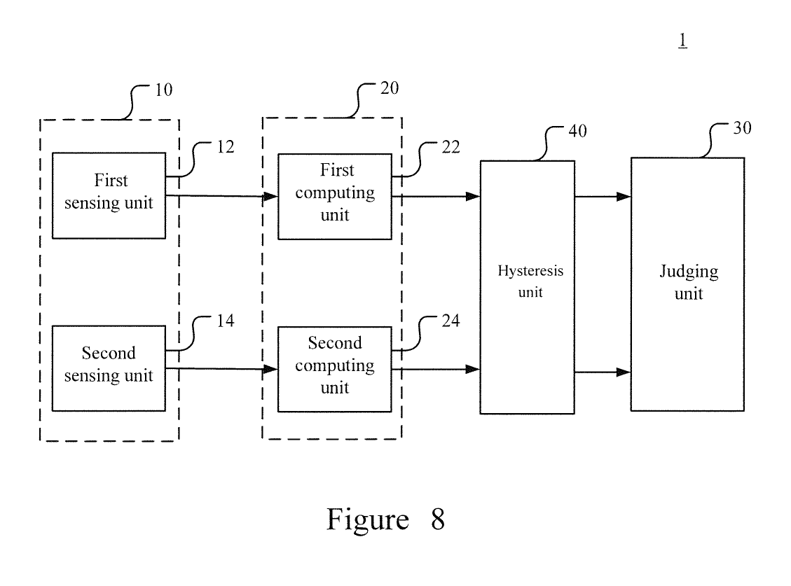

FIG. 8 shows a block diagram according to another preferred embodiment of the present invention. As shown in the figure, the direction sensing apparatus 1 according to the present embodiment further comprises a hysteresis circuit 40 coupled between the computing circuit 20 and the judging unit 30. The hysteresis circuit 40 compares the computing value output by the computing circuit 20 according to at least a digital hysteresis threshold value and produces an output signal. The judging unit 30 gives the state of gravity direction according to the output signal. The hysteresis effect described above is generated in an analog method. In the following, another embodiment for producing the hysteresis effect is provided by using a digital method.

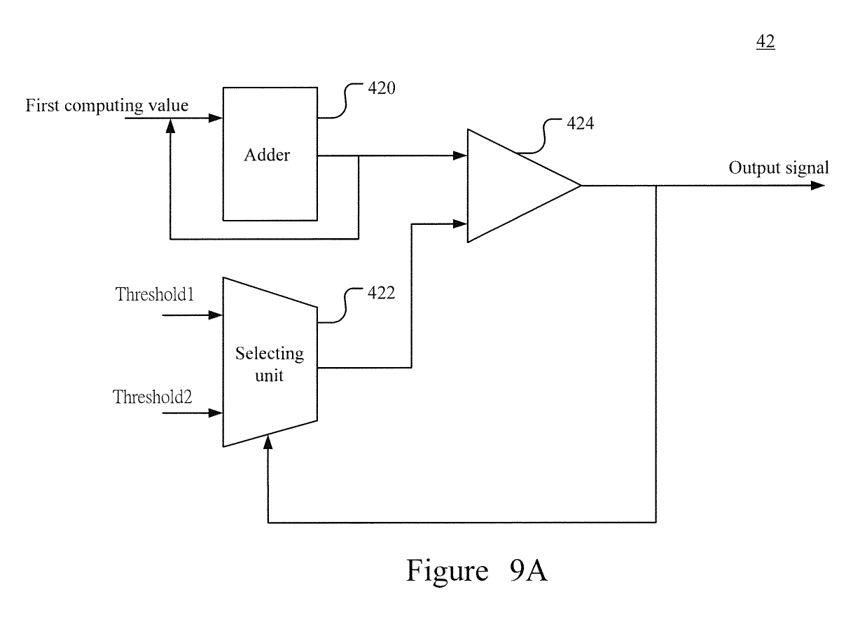

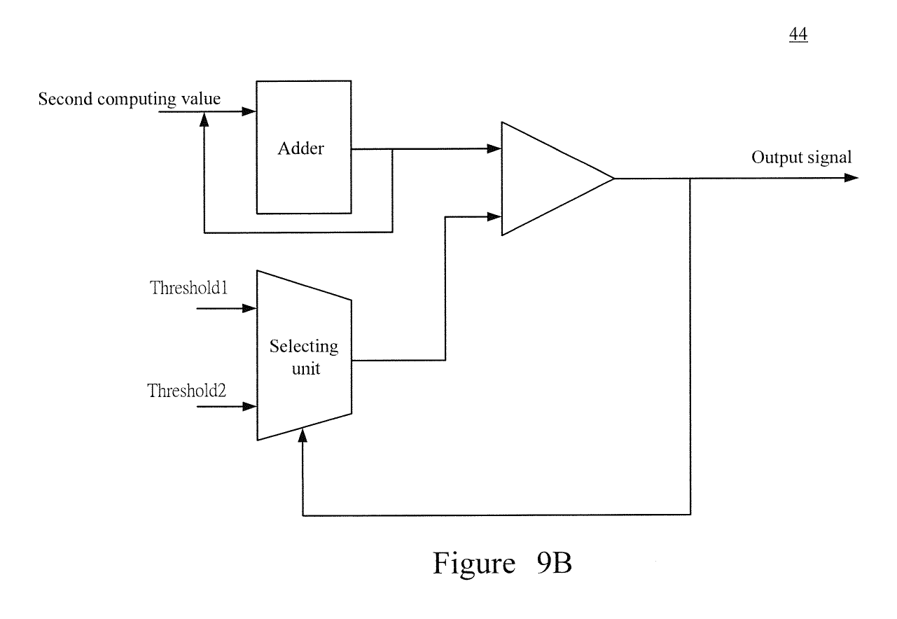

FIGS. 9A and 9B show circuit diagrams of the hysteresis circuit according to a preferred embodiment of the present invention. As shown in the figure, the hysteresis circuit 40 according to the present invention comprises a first hysteresis unit 42 and a second hysteresis unit 44. The first hysteresis unit 42 comprises an adder 420, a selecting unit 422, and a comparing unit 424. The adder 420 is coupled to the first computing unit 22 of the computing module 20. The adder 420 receives and accumulates the first computing value output by the first computing unit 22. The selecting unit 422 selects to output a first digital hysteresis threshold value Threshold 1 or a second digital hysteresis threshold value Threshold2. The comparing unit 424 is coupled to the adder 420 and the selecting unit 422, receiving the accumulated first computing value as well as the first digital hysteresis threshold value Threshold1 or the second digital hysteresis threshold value Threshold2, and comparing the first computing value output by the adder 420 with the first digital hysteresis threshold value Threshold 1 or comparing the first computing value with the second digital hysteresis threshold value Threshold2. Then the comparing unit 424 produces an output signal and transmits the output signal to the judging unit 30, which gives the state of gravity direction according to the output signal. The operating principle of the digital hysteresis method is the same as that of the analog method described above.

Because the first computing value output by the first computing unit 22 is one bit and the first digital hysteresis threshold value Threshold1 and the second digital hysteresis threshold value Threshold2 output by the selecting unit 422 are greater than one bit, the present embodiment uses the adder 420 to make the number of bits of the first computing value accumulated by the adder 420 identical to that of the first digital hysteresis threshold value Threshold1 or the second digital hysteresis threshold value Threshold2. Thereby, the comparing unit 424 can compare the accumulated first computing value with the first digital hysteresis threshold value Threshold1 or the second digital hysteresis threshold value Threshold2. Likewise, the circuit structure of the second hysteresis unit 44 is the same as that of the first hysteresis unit 42, and hence will not be described in details here. Moreover, the adder 420 can be integrated equivalently in the computing unit. The equivalent computing unit has an output with multiple bits (greater than one). Hence, the adder 420 in FIGS. 9A and 9B can be omitted.

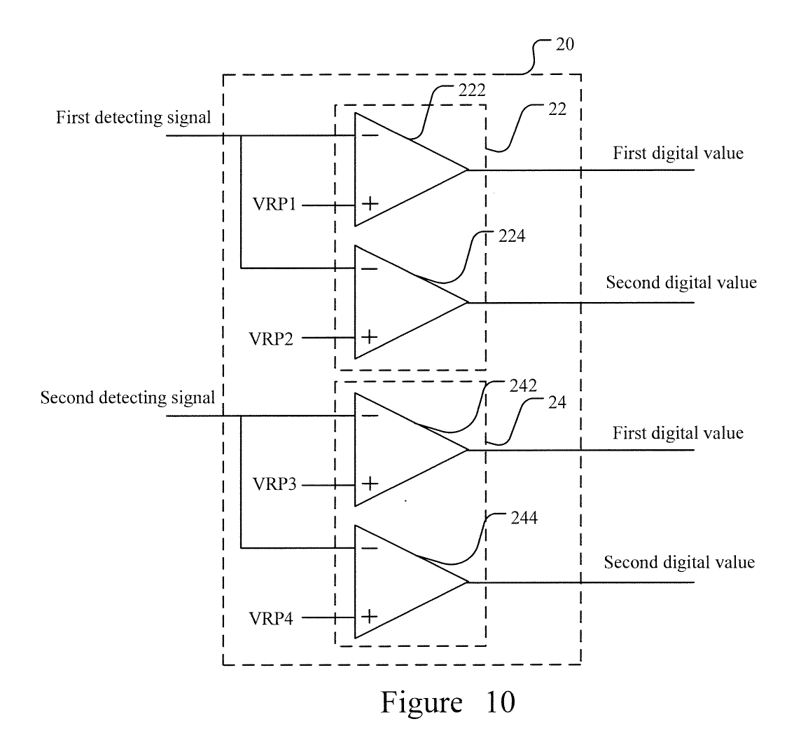

FIG. 10 shows a circuit diagram of the computing module according to another preferred embodiment of the present invention. As shown in the figure, the difference between the present embodiment and the one in FIG. 2 is that the first computing unit 22 of the computing module 20 according to the present embodiment compares the first detecting signal with a first hysteresis threshold value VRP1 and a second hysteresis threshold value VRP2 and produces the first computing value; the second computing unit 24 of the computing module 20 according to the present embodiment compares the second detecting signal with a third hysteresis threshold value VRP3 and a fourth hysteresis threshold value VRP4 and produces the second computing value.

The first computing unit 22 according to the present embodiment comprises a first comparing unit 222 and a second comparing unit 224. The first comparing unit 222 receives the first detecting signal and compares the first detecting signal with the first hysteresis threshold value VRP1 for producing a first digital value; the second comparing unit 224 receives the first detecting signal and compares the first detecting signal with the second hysteresis threshold value VRP2 for producing a second digital value. The first and the second digital values determine the first computing value. Likewise, the second computing unit 24 also comprises two comparing units 242, 244 for producing two digital values according to the third and the fourth hysteresis threshold values VRP3, VRP4 and determining the second computing value. The circuit structure of the second computing unit 24 is the same as that of the first computing unit 22, and hence will not be described in more details here.

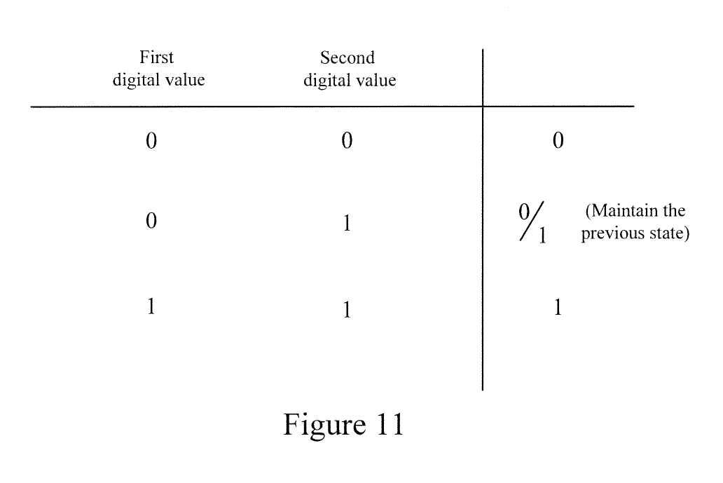

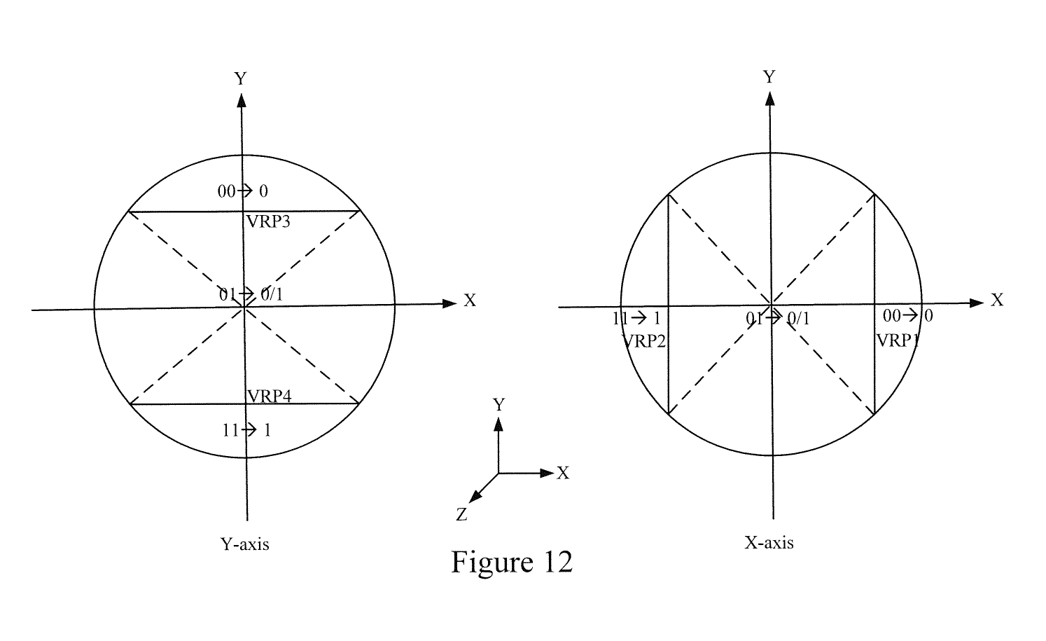

FIG. 11 shows an output truth table of the first computing unit in FIG. 10 and FIG. 12 shows a coordinate graph of the rotation angle on the sensing plane in FIG. 10 according to a preferred embodiment of the present invention. As shown in the figures, taking the first computing unit 22 in FIG. 10 for example, when the first and the second digital values are both 0, the first computing value is 0, which means that the object rotates clockwise over a certain angle. When the first and the second digital values are both 1, the second computing value is 1, which means that the object rotates counterclockwise over a certain angle. When the first digital value is 0 and the second digital value is 1, the previous state is maintained. Likewise, the operating principle of the second computing unit 24 is the same as the first computing unit 22, and will not be described again. It is known from the above that the judging unit 30 can receive the first and the second computing values and give the state of gravity direction.

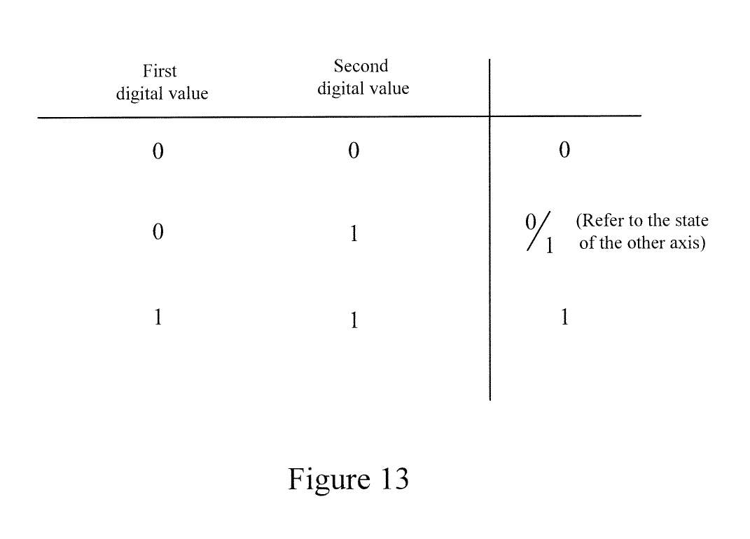

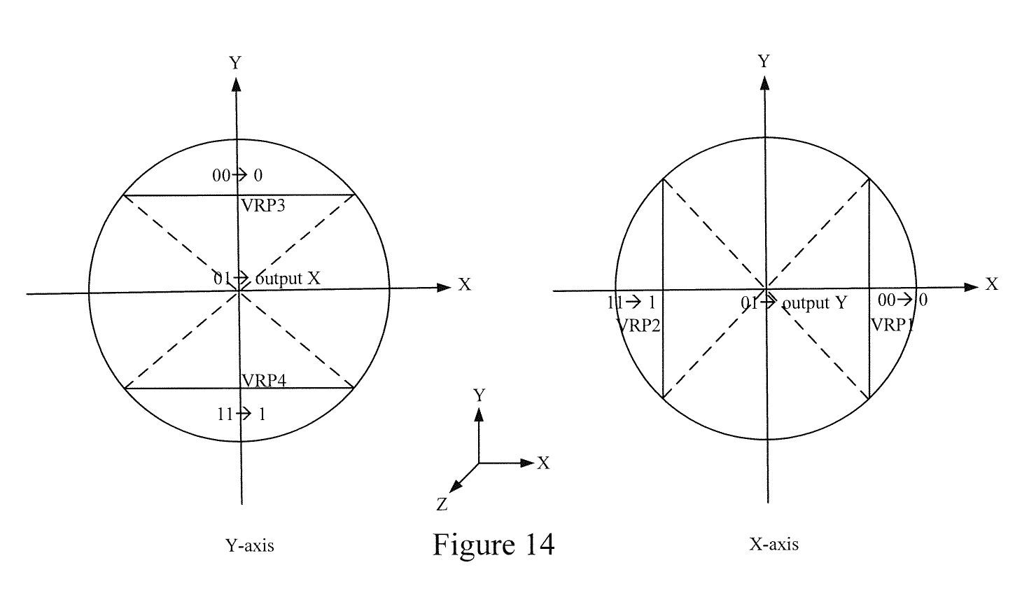

FIG. 13 shows an output truth table of the first computing unit in FIG. 10 and FIG. 14 shows a coordinate graph of the rotation angle on the sensing plane in FIG. 10 according to another preferred embodiment of the present invention. As shown in the figures, the difference between the truth table according to the present embodiment and the one according to the previous embodiment is that according to the present embodiment, when the first digital value is 0 and the second digital is 1, the state of direction of the other axis is adopted. That is to say, when the first computing value of the first computing unit 22 is 01 and the second computing value of the second computing unit 24 is 11, the first computing value is modified to 11 correspondingly.

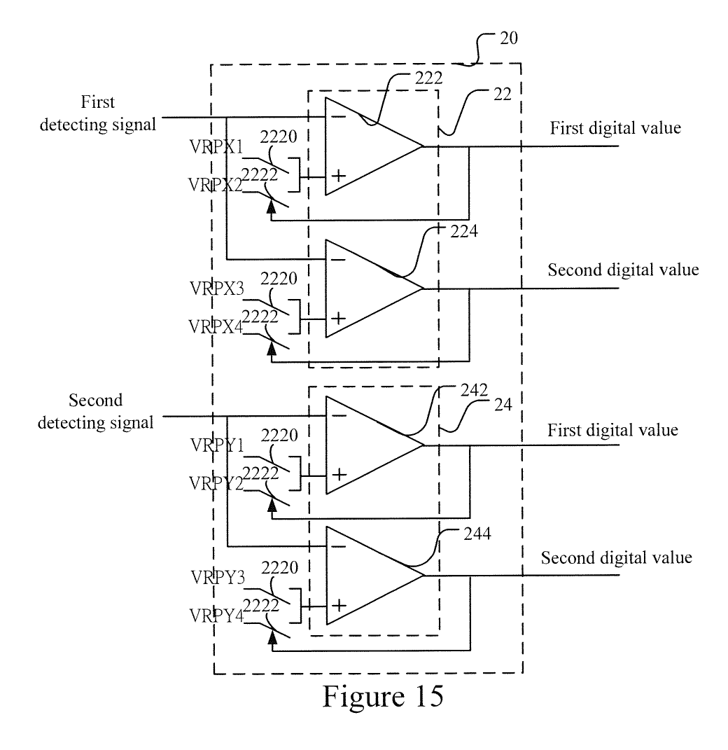

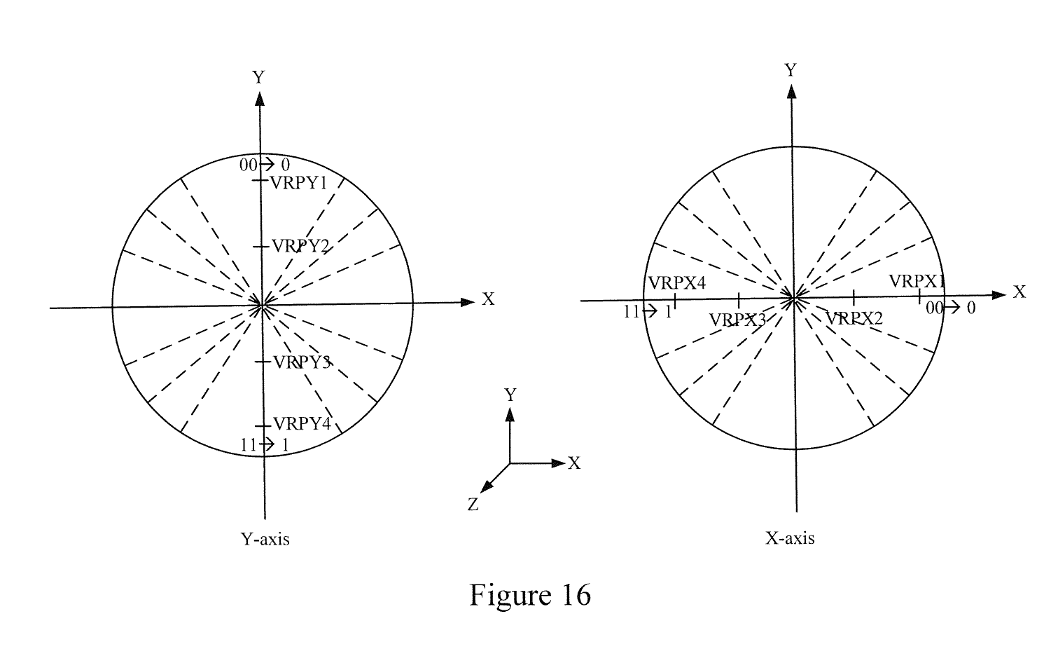

FIG. 15 shows a circuit diagram of the computing module and FIG. 16 shows a coordinate graph of the rotation angle on the sensing plane in FIG. 15 according to a preferred embodiment of the present invention. As shown in the figure, the difference between the present embodiment and the one in FIG. 10 is that the first comparing unit 222 according to the present embodiment further comprises a first switch 2220 and a second switch 2222. The first switch 2220 is coupled to the first comparing unit 222 and receives a first hysteresis threshold value VRPX1; the second switch 2222 is coupled to the first comparing unit 222 and receives a second hysteresis threshold value VRPX2. The first and the second switches 2220, 2222 are controlled by the first digital value of the first comparing unit 222. The first and the second switches 2220, 2222 transmit the first hysteresis threshold value VRPX1 or the second hysteresis threshold value VRPX2 to the first comparing unit 222 according to the first digital value. Likewise, the structure of the second comparing unit 224 is identical to that of the first comparing unit 22, and hence will not be described in details. Besides, the circuit structure of the second computing unit 24 according to the present embodiment is the same as that of the first computing unit 22, so the circuit structure will not be repeated again. Thereby, the present embodiment can further improve the stability of switching the screen when the direction sensing apparatus 1 senses rotations of the object by means of multiple comparing units and the hysteresis control signal.

To sum up, the direction sensing apparatus according to the present invention comprises a sensing circuit, a computing module, and a judging unit. The sensing circuit detects the gravity direction of an object and produces at least a detecting signal. The computing module receives the detecting signal, and produces at least a computing value according to at least a threshold value and the detecting signal. The judging unit receives the computing value, and gives a state of gravity direction of the object according to the computing value. Thereby, the present invention shrinks the area of circuits and hence saving cost by means of the simple circuit structure of the computing module.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A direction sensing apparatus, comprising:
a sensing circuit, detecting the gravity direction of an object, and producing at least a detecting signal;
a computing module, receiving said detecting signal, and producing at least a computing value according to at least a threshold value and said detecting signal; and
a judging unit, receiving said computing value, and giving a state of gravity direction of said object according to said computing value.

2. The direction sensing apparatus of claim 1, wherein said computing module further receives at least a hysteresis control signal and compares said detecting signal according to said hysteresis control signal and said threshold value for producing said computing value.

3. The direction sensing apparatus of claim 1, wherein said sensing circuit comprises:
a first sensing unit, detecting motion of said object along a first axis, and producing a first detecting signal; and
a second sensing unit, detecting motion of said object along a second axis, and producing a second detecting signal.

4. The direction sensing apparatus of claim 3, wherein said computing module comprises:
a first computing unit, receiving said first detecting signal, and producing a first computing value according to a first threshold value and said first detecting signal; and
a second computing unit, receiving said second detecting signal, and producing a second computing value according to a second threshold value and said second detecting signal;
where said judging unit judges said state of gravity direction of said object according to said first computing value and said second computing value.

5. The direction sensing apparatus of claim 4, wherein said first computing unit or said second computing unit includes a comparing unit having a first input and a second input; said first input receives said first detecting signal or said second detecting signal; and said second input receives said first hysteresis threshold value or said second hysteresis threshold value for outputting said first computing value or said second computing value.

6. The direction sensing apparatus of claim 5, wherein said first computing unit or/and said second computing unit further comprises:
a first switch, coupled to said second input of said comparing unit, and receiving a first hysteresis threshold value; and
a second switch, coupled to said second input of said comparing unit, and receiving a second hysteresis threshold value;
where said first switch and said second switch are controlled by said first computing value or said second computing value; said first computing value and said second computing value are hysteresis control signals; said first switch or said second switch transmits said first hysteresis threshold value or said second hysteresis threshold value to said second input of said comparing unit according to said hysteresis control signal; and said comparing unit compares said first detecting signal or said second detecting signal with selected hysteresis threshold value for producing said first computing value or said second computing value.

7. The direction sensing apparatus of claim 3, wherein said computing module comprises:
a first computing unit, receiving said first detecting signal, and comparing said first detecting signal according to a first hysteresis threshold value and a second hysteresis value for producing a first computing value; and
a second computing unit, receiving said second detecting signal, and comparing said second detecting signal according to a third hysteresis threshold value and a fourth hysteresis value for producing a second computing value.

8. The direction sensing apparatus of claim 7, wherein said first computing unit or/and said second computing unit comprises:
a first comparing unit, receiving said first detecting signal, comparing said first detecting signal according to said first hysteresis threshold value for producing a first digital value; and
a second comparing unit, receiving said first detecting signal, comparing said first detecting signal according to said second hysteresis threshold value for producing a second digital value;
where said first digital value and said second digital value determine said first computing value.

9. The direction sensing apparatus of claim 8, wherein said first comparing unit or/and said second comparing unit further comprises:
a first switch, coupled to said first comparing unit or said second comparing unit, and receiving a first hysteresis threshold value; and
a second switch, coupled to said first comparing unit or said second comparing unit, and receiving a second hysteresis threshold value;
where said first switch and said second switch are controlled by said first digital value or said second digital value; said first digital value and said second digital value are a first hysteresis control signal and a second hysteresis control signal, respectively; said first switch or said second switch transmits said first hysteresis threshold value or said second hysteresis threshold value to said first comparing unit or said second comparing unit according to said first hysteresis control signal or said second hysteresis control signal; and said first comparing unit or said second comparing unit compares said first detecting signal or said second detecting signal for producing said first digital value or said second digital value according to said first hysteresis threshold value or said second hysteresis threshold value.

10. The direction sensing apparatus of claim 1, and further comprising a hysteresis circuit, coupled to said computing circuit, comparing said computing value for producing an output signal according at least a digital hysteresis threshold value, and said judging unit giving said state of gravity direction of said object according to said output signal.

11. The direction sensing apparatus of claim 10, wherein said hysteresis circuit comprises:
an adder, coupled to said computing module for receiving and accumulating said computing value, and outputting said accumulated computing value;
a selecting unit, selecting to output a first digital hysteresis threshold value or a second digital hysteresis threshold value; and
a comparing unit, coupled to said adder and said selecting unit, comparing said accumulated computing value output by said adder with said first digital hysteresis threshold value or said digital hysteresis threshold value, producing an output signal, and said judging unit giving said state of gravity direction of said object according to said output signal.
